(19) United States
(12) Patent Application Publication
(10) Pub. No.: US 2012/0093512 A1
(43) Pub. Date: Apr. 19, 2012

(54) METHOD OF MANAGING ONTS IN PON AND OLT FOR MANAGING THE SAME

(76) Inventors: Bo Kil LEE, Seongnam-si (KR); Yu Sik NA, Seoul (KR)

(21) Appl. No.: 12/959,682

(22) Filed: Dec. 3, 2010

(30) Foreign Application Priority Data
Oct. 14, 2010 (KR) 10-2010-0100154

(51) Int. Cl. H04J 14/00

(52) U.S. Cl. 398/66

(57) ABSTRACT

A method of managing optical network terminals (ONTs) and an optical line terminal (OLT) for managing the ONTs are provided. A method of managing ONTs in an OLT includes receiving ONT type information in management information base (MIB) information of ONTs connected to the OLT from the ONTs; not uploading MIBs of other ONTs having the same type as the ONT when MIB upload data for the other ONTs is present in the OLT, and uploading the MIBs of the other ONTs having the same type as the ONT when the MIB upload data for the other ONTs is not present in the OLT; and driving an interface of the ONT.

### TECHNICAL FIELD

The described technology relates generally to a method of managing optical network terminals (ONTs) in a passive optical network (PON), and an optical line terminal (OLT) for managing the ONTs.

### BACKGROUND

Passive optical network (hereinafter, referred to as PON) technology is used as Fiber to the home (FTTH) technology. The PON technology is classified into ATM PON (APON) (or Broadband PON; BPON), Ethernet PON (EPON), and Gigabit PON (GPON) depending on transfer protocol schemes. The GPON includes one optical line terminal (hereinafter, referred to as OLT) and a plurality of optical network terminals (hereinafter, referred to as ONT) connected in a point-to-multipoint configuration.

### SUMMARY

An object of the described technology is to provide a method capable of reducing overhead by an optical line terminal (OLT) not performing management information base (MIB) upload on other optical network terminals (ONTs) having the same type (e.g., the same ONT model or operating system version) as a first ONT after performing MIB upload on the first ONT.

In one embodiment, a method of managing ONTs in an OLT is provided. The method includes receiving ONT type information in MIB information of ONTs connected to the OLT from the ONTs; not uploading MIBs of other ONTs having the same type as the ONT when MIB upload data for the other ONTs is present in the OLT, and uploading the MIBs of the other ONTs having the same type as the ONT when the MIB upload data for the other ONTs is not present in the OLT; and driving an interface of the ONT.

In another embodiment, a method of managing ONTs in an OLT is provided. The method includes receiving ONT type information in MIB information of an ONT connected to the OLT from the ONT when the ONT is rebooted; not uploading MIBs of other ONTs having the same type as the ONT when MIB upload data for the other ONTs is present in the OLT, and uploading the MIBs of the other ONTs having the same type as the ONT when the MIB upload data for the other ONTs is not present in the OLT; and driving an interface of the ONT.

In yet another embodiment, an OLT is provided. The OLT includes a database unit; a receiving unit for receiving ONT type information in MIB information of a connected ONT; an MIB upload unit for uploading MIBs of other ONTs having the same type as the ONT when MIB upload information for the other ONTs is not present in the database; and an ONT driving unit for controlling driving of an interface of the ONT.

The described technology can have the following effects. However, since it is not intended that a specific embodiment includes all the effects or only the effects, it should not be understood that the described technology is limited thereby.

According to the described technology, it is possible to efficiently upload the MIBs of ONTs. Accordingly, it is possible to reduce system overhead caused by MIB upload. For example, according to the described technology, it is possible to reduce transmission overhead between the OLT and the ONT or overhead of an OLT database space, which is caused by the MIB upload.

The Summary is provided to introduce a selection of concepts in a simplified form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIG. 1 is a flow diagram illustrating signals transmitted and received between an OLT, a first ONT and a second ONT according to an embodiment of the described technology;

FIG. 2 is a flowchart showing a method of managing ONTs in a PON according to an embodiment of the described technology; and

FIG. 3 is a block diagram showing an OLT according to an embodiment of the described technology.

### DETAILED DESCRIPTION

It will be readily understood that the components of the present disclosure, as generally described and illustrated in the figures herein, could be arranged and designed in a wide variety of different configurations. Thus, the following more detailed description of the embodiments of apparatus and methods in accordance with the present disclosure, as represented in the figures, is not intended to limit the scope of the disclosure, as claimed, but is merely representative of certain examples of embodiments in accordance with the disclosure. The presently described embodiments will be best understood by reference to the drawings, wherein like parts are designated by like numerals throughout. Moreover, the drawings are not necessarily to scale, and the size and relative sizes of the layers and regions may have been exaggerated for clarity.

Meanwhile, meaning of terminology used herein will be understood as follows:

The terminology used herein is for the purpose of describing particular embodiments only and is not intended to be limiting of example embodiments. The singular forms “a,” “an” and “the” are intended to include the plural forms as well, unless the context clearly indicates otherwise. It will be further understood that the terms “comprises,” “comprising,” “includes” and/or “including” specify the presence of stated features, integers, steps, operations, elements and/or components, but do not preclude the presence or addition of one or more other features, integers, steps, operations, elements, components and/or groups thereof.

Steps noted may occur out of noted order, unless the context clearly indicates specific order. For example, the steps may be executed substantially concurrently or may sometimes be executed in the reverse order.

Unless defined otherwise herein, all terms used herein have the same meanings as commonly understood by one of ordinary skill in the art to which the described technology belongs. Terms defined in commonly used dictionaries should be interpreted as having a meaning that is consistent with their meaning in the context of relevant art and should not be interpreted in an idealized or overly formal sense unless expressly so defined herein.

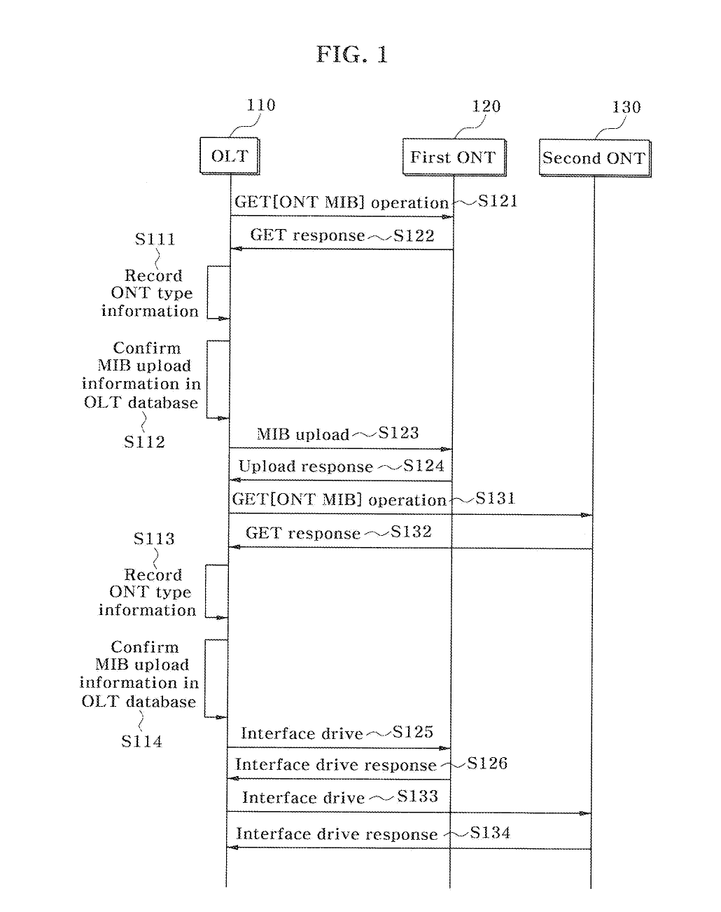

FIG. 1 is a flow diagram illustrating signals transmitted and received between an optical line terminal (OLT), a first optical network terminal (ONT) and a second ONT according to an embodiment of the described technology. Referring to FIG. 1, a method of managing ONTs in a passive optical network (PON) is involved in information exchange between the OLT 110 and the first ONT 120 or the second ONT 130.

In a Gigabit PON (GPON), an ONT management control interface (OMCI; ITU-T G.984.4) protocol is used for the OLT to manage connected ONTs. The OLT needs to know management information base (hereinafter, referred to as ‘MIB’) information in order to manage the ONTs through the OMCI, and always to maintain the same number of MIBs as the ONTs. Accordingly, when a new ONT is connected or a connected ONT is rebooted, the OLT requests the ONT to provide MIB information and the ONT uploads its MIB data as a response. The uploaded MIB data (hereinafter, referred to as MIB upload data) is stored in an OLT database.

The OLT 110 according to the described technology provides a method by which MIB can be efficiently uploaded. The OLT 110 does not upload MIB data each time a new ONT is connected or an ONT is rebooted, but performs MIB upload only when MIB data upload is necessary as a result of judging whether the MIB data upload is necessary. For example, MIBs of ONTs having the same model type or operating system version may have the same content. When an ONT judged as using the same MIB data as MIB upload data already uploaded in the OLT 110 is newly connected or rebooted, the MIB upload may not be performed. Hereinafter, a method by which the OLT 110 uploads the MIB according to the described technology will be described in detail.

When the first ONT 120 is connected to the OLT 110, the OLT 110 sends a GET operation to the first ONT 120 to request ONT type information for judgment of the type of the first ONT 120 (S121). In this case, the ONT type information is information for identifying the type of hardware or software of the ONT, and may include a model type of the ONT, an operating system version of the ONT, and the like. The first ONT 120 having received the GET operation 121 sends a GET response including the ONT type information as an attribute value (S122). The GET operation is used to read the attribute value of the ONT, and the ONT sends the GET response including the requested attribute value.

The OLT 110 having received the GET response records the type information of the first ONT 120 in the OLT database (S111). For example, the OLT 110 may record the model type of the ONT, a previous operating system version of the ONT, a current operating system version of the ONT, an OLT identifier, an ONT identifier, upload necessity, or the like.

The OLT 110 judges whether MIB upload data for an ONT having the same type as the first ONT 120 is stored in the OLT database (S112). For example, the OLT 110 may judge whether MIB upload data for an ONT having the same model type as the first ONT 120 is present. Alternatively, the OLT 110 may judge whether MIB upload data for an ONT having the same model type and operating system version as the first ONT 120 is present. When the OLT 110 judges that the MIB upload data is not present, the OLT 110 requests the first ONT 120 to perform MIB upload (S123). The first ONT 120 having received the request for the MIB upload responds to the MIB upload request and the OLT 110 performs the MIB upload (S124). The OLT 110 updates the database with the MIB information received from the first ONT 120. The MIB upload is used when the OLT 110 reads all MIB data of the ONT. All instances of the ONT are reported to the OLT 110. In a MIB upload protocol, the OLT 110 asks the ONT about the number of instances and reads all the instance values while asking the ONT a number of times corresponding to the number answered by the ONT.

According to an embodiment, the OLT 110 may upload MIB data of a first connected ONT without judging, for the first connected ONT, whether MIB upload data of the same type is present.

When the second ONT 130 is connected to the OLT 110 after the MIB upload for the first ONT 120 in the OLT 110 is terminated, the OLT 110 sends a GET operation to the second ONT 130 in order to judge the type of the second ONT 130 (S131). The second ONT 130 having received the GET operation 131 sends a GET response including ONT type information as an attribute value (S132).

The OLT 110 having received the GET response records the type information of the second ONT 120 in the OLT database (S113). The ONT type information may include an OLT identifier, an ONT identifier, a model type, a previous operating system version, a current operating system version, or upload necessity.

The OLT 110 having recorded the type information of the second ONT 130 compares the type information with the OLT database. When the OLT 110 judges that MIB upload data for the same ONT type as that of the second ONT 130 is not present in the OLT database, the OLT 110 requests the second ONT 130 to upload the MIB. The judgment as to whether MIB upload data for the same ONT type as that of the second ONT 130 is present may be based on the model type, the operating system version, or the like, as described above. The second ONT 130 having received the MIB upload request performs the MIB upload, and the OLT 110 updates the OLT database with the MIB information received from the second ONT 130. On the other hand, when the MIB upload data for the same ONT type as that of the second ONT 130 has already been present in the OLT database, the OLT 110 may not request the second ONT 130 to perform the MIB upload (S114). In this case, the OLT 110 may copy or reference the existing MIB upload data and use the MIB upload data to manage the second ONT 130.

According to the described technology, the MIB upload is performed for the ONT first connected to the OLT, and then the MIB upload is not performed for other ONTs having the same type as the first connected ONT when the other ONTs are connected, making it possible to reduce waste of the database space and the overhead, thus avoiding system overload.

Accordingly, according to the described technology, the MIB upload need not be repeatedly performed when the same type of ONT is connected. Accordingly, when a greater number of ONTs having the same type are provided, MIB upload overhead further decreases. Further, according to an embodiment of the described technology, the OLT 110 stores only one MIB upload data for each ONT type, which is referenced and used for a plurality of ONTs, thus efficiently managing the database space of the OLT.

Meanwhile, the first ONT 120 or the second ONT 130 may be rebooted after the first ONT 120 or the second ONT 130 is connected to the OLT 110. An ONT may be rebooted when an operating system of the ONT is upgraded or the ONT has a problem. Since MIB information of a rebooted ONT may be changed when the ONT is rebooted, for example, due to upgrade of the operating system, the MIB upload needs to be performed again. Accordingly, even when the first ONT 120 or the second ONT 130 is rebooted, the MIB upload is performed, as in the case in which the ONT is newly connected.

When the MIB upload process as described above is completed, the OLT 110 sends configuration information for driving an interface to the first ONT 120 (S125). When the first ONT 120 responds to the OLT 110 after receiving the configuration information, service is initiated (S126). The OLT 110 also sends configuration information for driving an interface to the second ONT 130 (S133). When the second ONT 130 responds to the OLT 110 after receiving the configuration information, service is initiated (S134).

In the method of managing the ONTs according to an embodiment of the described technology, the MIB upload is performed only when an ONT having the same type is not present when a new ONT is connected or a connected ONT is rebooted, thereby reducing transmission overhead caused by the MIB upload. Further, according to another embodiment of the described technology, MIBs for all ONTs need not be stored in the OLT, but only one MIB is stored for the same type of ONTs, thus reducing overhead of the OLT database space.

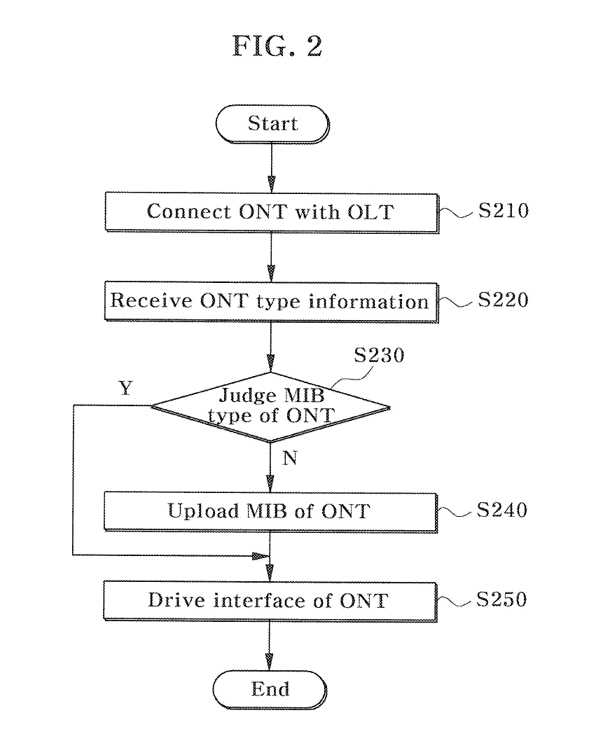

FIG. 2 is a flowchart showing a method of managing ONTs in a PON according to an embodiment of the described technology. Referring to FIG. 2, the OLT is connected with the ONT in step S210. The connection of the OLT 110 with the ONT includes a connection with a first ONT, as well as a connection with another ONT following the connection with the first ONT, and a reboot of a previously connected ONT.

In step S220, the OLT 110 receives ONT type information in the MIB information of the connected ONT. In order to receive the ONT type information, the OLT 110 sends a GET operation to the ONT to request the ONT type information, and the ONT sends a requested attribute value as a response. The ONT type information may include an OLT identifier, an ONT identifier, a model type, a previous operating system version, a current operating system version, and the like. The OLT 110 judges whether to upload the MIB based on the received ONT type information.

In step S230, the OLT 110 judges whether to upload the MIB of the ONT based on the received ONT type information. According to an embodiment, the OLT 110 uploads the MIB when MIB upload data for an ONT having the same type as the received ONT type is not present in the OLT database. On the other hand, when the MIB upload data for the ONT having the same type as the received ONT type is present in the OLT database, the OLT 110 may not upload the MIB. The judgment as to whether the ONT has the same type may be based on the model type or the operating system version. When the OLT 110 does not upload the MIB, the fact that the ONT for which the GET response is received in step S220 has the type known to the OLT 110 may be stored in the OLT database.

In step S240, the MIB upload for the ONT is performed. When the MIB upload data for an ONT having the same type as the received ONT type is not present in the OLT database, the OLT 110 uploads the MIB data.

In step S250, the OLT 110 drives an interface of the ONT. For the ONT for which the MIB upload has been performed or the ONT for which the upload has not been performed due to the presence of the same MIB in the OLT 110, the OLT 110 drives the interface of each ONT.

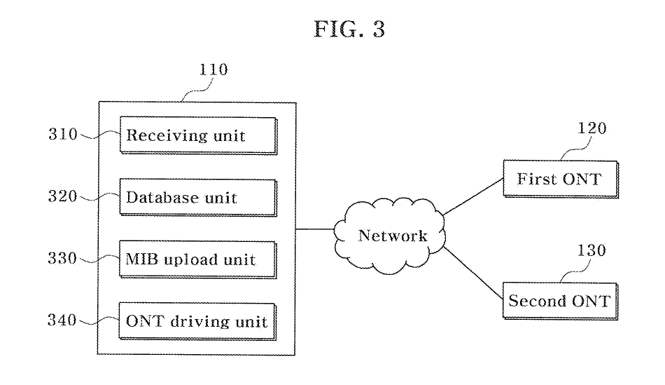

FIG. 3 is a block diagram showing an OLT according to an embodiment of the described technology. Referring to FIG. 3, an OLT 110 includes a receiving unit 310, a database unit 320, an MIB upload unit 330, and an ONT driving unit 340. According to an embodiment, the OLT 110 may operate on a GPON.

The receiving unit 310 receives ONT type information in the MIB information of a connected ONT. The ONT type information may include an OLT identifier, an ONT identifier, a model type, a previous operating system version, a current operating system version, and the like.

The database unit 320 stores the ONT type information received by the receiving unit 310. Further, when a MIB is uploaded from the ONT connected to the OLT 110, the database unit 320 may store MIB upload data.

When MIB upload data for another ONT having the same type as the connected ONT is not present in the database unit 320, the MIB upload unit 330 uploads the MIB of the other ONT. Even when the connected ONT is rebooted, the MIB upload unit 330 does not upload the MIB of the ONT when MIB upload data for another ONT having the same type as the rebooted ONT is present in the database unit 320, and uploads the MIB of the ONT when the MIB upload data is not present in the database unit 320.

The ONT driving unit 340 drives the interface of the ONT after the upload for the connected ONT is terminated.

The foregoing is illustrative of the present disclosure and is not to be construed as limiting thereof. Although numerous embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A method of managing optical network terminals (ONTs) in an optical line terminal (OLT), the method comprising:
receiving ONT type information in management information base (MIB) information of ONTs connected to the OLT from the ONTs;
not uploading MIBs of other ONTs having the same type as the ONT when MIB upload data for the other ONTs is present in the OLT, and uploading the MIBs of the other ONTs having the same type as the ONT when the MIB upload data for the other ONTs is not present in the OLT; and
driving an interface of the ONT.

2. The method according to claim 1, wherein the ONT type information comprises a model type of the ONT or an operating system version of the ONT.

3. The method according to claim 1, wherein when the MIB upload data for the other ONTs having the same type as the ONT is present in the OLT, the MIB upload data is copied and used to manage the ONTs in the OLT.

4. The method according to claim 1, wherein when the MIB upload data for the other ONTs having the same type as the ONT is present in the OLT, the MIB upload data is referenced and used to manage the ONTs.

5. The method according to claim 1, wherein the OLT and the ONT operate on a gigabit passive optical network (GPON).

6. The method according to claim 1, wherein the uploading of the MIB comprises uploading entire MIB data of the ONT to the OLT database.

7. The method according to claim 1, further comprising, after the receiving of the ONT type information,
recording an OLT identifier, an ONT identifier, a model type, a previous operating system version, a current operating system version, or upload necessity on the OLT based on the received ONT type information.

8. A method of managing optical network terminals (ONTs) in an optical line terminal (OLT), the method comprising:
receiving ONT type information in management information base (MIB) information of an ONT connected to the OLT from the ONT when the ONT is rebooted;
not uploading MIBs of other ONTs having the same type as the ONT when MIB upload data for the other ONTs is present in the OLT, and uploading the MIBs of the other ONTs having the same type as the ONT when the MIB upload data for the other ONTs is not present in the OLT; and
driving an interface of the ONT.

9. The method according to claim 8, wherein the OLT and the ONT operates on a gigabit passive optical network (GPON).

10. The method according to claim 8, wherein the uploading of the MIB comprises uploading the entire MIB data of the ONT to the OLT database.

11. The method according to claim 8, further comprising, after the receiving of the ONT type information,
recording an OLT identifier, an ONT identifier, a model type, a previous operating system version, a current operating system version or upload necessity on the OLT based on the received ONT type information.

12. An optical line terminal (OLT) comprising:
a database unit;
a receiving unit for receiving optical network terminal (ONT) type information in management information base (MIB) information of a connected ONT;
an MIB upload unit for uploading MIBs of other ONTs having the same type as the ONT when MIB upload information for the other ONTs is not present in the database; and
an ONT driving unit for controlling driving of an interface of the ONT.

13. The OLT according to claim 12, wherein the OLT operates on a gigabit passive optical network (GPON).

14. The OLT according to claim 12, wherein the ONT type information comprises an OLT identifier, an ONT identifier, a model type, a previous operating system version, a current operating system version, or upload necessity.

15. The OLT according to claim 12, wherein the receiving unit receives the ONT type information in the MIB information of the ONT when the ONT is rebooted, and
the MIB upload unit does not upload MIBs of other ONT having the same type as the rebooted ONT when MIB upload information for other ONTs is present in the OLT, and uploads the MIBs of the other ONT having the same type as the rebooted ONT when the MIB upload information for the other ONTs is not present in the OLT.
